(19) United States
(12) Patent Application Publication
(10) Pub. No.: US 2010/0257318 A1
(43) Pub. Date: Oct. 7, 2010

(54) EVICTING CODE SECTIONS FROM SECONDARY MEMORY TO IMPROVE THE SECURITY OF COMPUTING SYSTEMS

(75) Inventors: Onur Aciicmez, San Jose, CA (US); Xinwen Zhang, San Jose, CA (US); Jean-Pierre Seifert, Tirol (AT)

Correspondence Address: Beyer Law Group LLP/ SISA, P.O. Box 1687, Cupertino, CA, 95015-1687, US

(73) Assignee: SAMSUNG ELECTRONICS CO., LTD., Suwon City (KR)

(21) Appl. No.: 12/418,033

(22) Filed: Apr. 3, 2009

(51) Int. Cl. G06F 12/08; G06F 9/44

(52) U.S. Cl. 711/125; 717/110; 711/135; 711/E12.02; 717/162; 711/122; 711/E12.024; 711/E12.022

(57) ABSTRACT

Executable computer code sections can be effectively evicted from secondary memory (e.g., instruction cache) during execution time in order to reduce the observable changes to the state of the secondary memory, thereby enhancing the security of computing systems that use secondary memory in addition the primary (main) memory to support execution of computer code. In particular, codes sections considered to be critical to security can be identified and effectively mapped to the same section of an instruction cache (I-cache) as provided in more modern computing systems in order to improve the efficiency of execution, thereby allowing use of the I-cache in a more secure manner.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information is stored in a computer readable medium in a binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known as an Operating System (OS) which provides programmers with an interface used to access these resources and services.

Today, numerous types of computing devices are available. These computing devices widely range with respect to size, cost, amount of storage and processing power. The computing devices that are available today include: expensive and powerful servers, relatively cheaper Personal Computers (PC's) and laptops and yet less expensive microprocessors (or computer chips) provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

A Central Processing Unit (CPU) cache is a cache that can be used to reduce the average time it takes the CPU to access memory. A CPU cache can be smaller but faster memory storing copies of data from the most frequently used main memory locations. If most memory accesses are cached memory locations, the average latency of memory accesses will be closer to the cache latency rather than to the latency of main memory. When the processor needs to read from or write to a location in main memory, it can first determine whether a copy of that data is in the cache. If so, the processor can immediately read from or write to the CPU cache, which can be much faster than reading from or writing to main memory.

Today, computing systems (e.g., modern desktop and server) can have CPUs with at least three independent caches: an instruction cache (I-cache) to speed up fetching executable instructions, a data cache (D-cache) to speed up data fetch and store, and a translation lookaside buffer used to speed up virtual-to-physical address translation for both executable instructions and data.

The popularity of computing systems is evidenced by their ever increasing use in everyday life. Accordingly, techniques that can further improve computing systems would be very useful.

### SUMMARY OF THE INVENTION

Broadly speaking, the invention relates to computing systems and computing environments. More particularly, the invention pertains to improved techniques for using secondary memory.

In accordance with one aspect of the invention, data that effectively identify one or more executable computing code sections to be evicted from the secondary memory (“secondary-memory-eviction data”) can be generated, thereby reducing the observable state changes of the secondary memory with respect to the code sections that are evicted from secondary. In one embodiment, computer program code is obtained in order to generate secondary-memory-eviction data that effectively identifies at least a first executable computer code section of the computer program code as a section to be evicted from the secondary memory during the execution of the computer program code. It should be noted that the secondary-memory-eviction data can be stored in a computer readable storage medium. It should also be noted that the secondary-memory-eviction data can be effectively integrated with executable computer code generated for the computer program code. By way of example, a compiler can be operable to generate executable code that includes secondary-memory-eviction data identifying one or more executable computer code sections to be selectively evicted from the secondary memory, as will be appreciated by those skilled in the art.

In accordance with another aspect of the invention, one or more executable computer code sections can be evicted from secondary memory when context of the execution is to change (e.g., when context of the execution is to switch from a first context of execution for a first process to second context of execution for a second process). Executable computer code sections can be evicted selectively or the entire secondary memory, or at least a designated portion of the secondary memory can be invalidated to effectively evict executable computer program code from the secondary memory when context of the execution is to change.

In accordance with another aspect of the invention, one or more executable computer code sections can be evicted from secondary memory when context of the execution is to change (e.g., when context of the execution is to switch from a first context of execution for a first process to second context of execution for a second process). Executable computer code sections can be evicted selectively (or invalidated) from the second memory, or the entire secondary memory can be evicted, or at least designated portion of the secondary memory can be invalidated to effectively evict executable computer program code from the secondary memory when context of the execution is to change.

Those skilled in the art will also appreciate that the invention is especially suitable for enhancing the security of computing systems that use an instruction cache (I-cache). In particular, the invention allows selecting the sections of computer code considered to be important to security and ensuring that the executable sections are evicted from the I-cache before allowing the context of the execution to change. As a result, it would be difficult for a “spy” program to obtain information regarding the code sections by effectively observing the state changes of the I-cache.

The invention can be implemented in numerous ways, including, for example, a method, an apparatus, a computer readable (and/or storable) medium, and a computing system (e.g., a computing device). A computer readable medium can, for example, include at least executable computer program code stored in a tangible form. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing system 100 in accordance with one embodiment of the invention.

FIG. 1B depicts a computing system in accordance with another embodiment of the invention.

FIG. 2A depicts a method for generating data for execution of executable computer code by a computing system in accordance with one embodiment of the invention.

FIG. 2B depicts a method for executing executable computer code in accordance with one embodiment of the invention.

FIG. 3 depicts placement of executable code in an I-cache.

FIG. 4 depicts an Executable and Linking Format (or ELF) file in accordance with one embodiment of the invention.

FIG. 5 depicts an exemplary “process descriptor” in accordance with one embodiment of the invention.

### DETAILED DESCRIPTION OF THE INVENTION

As noted in the background section, a CPU (or a microprocessor) can use an instruction cache (I-cache) to effectively improve the performance of a computing system. An Instruction cache (I-cache) can store most frequently executed instructions and allow a CPU to access them faster than accessing them from the main memory. While increasing the performance of the system, an I-cache can introduce security issues.

One issue is that changes (or state changes) of the I-cache can be observed during the execution of a computer program in order to obtain sensitive information pertaining to the computer program. By way of example, an adversary component can execute “spy” code/process that keeps track of the changes in the state of an I-cache (e.g., changes to metadata during the execution of a cipher process). The spy code/process can run simultaneously or quasi-parallel with the cipher process and determine which instructions are executed by the cipher and thereby learn sensitive information, for example, including, secret keys (e.g., RSA keys).

More generally, conventional use of secondary memory (e.g., an I-cache) provided for execution of computer code can compromise security. Accordingly, techniques that allow use of secondary memory in a more secure manner are needed and would be very useful.

The invention relates to computing systems and computing environments. More particularly, the invention pertains to improved techniques for using secondary memory.

In accordance with one aspect of the invention, data that effectively identify one or more executable computing code sections to be evicted from the secondary memory (“secondary-memory-eviction data”) can be generated, thereby reducing the observable state changes of the secondary memory with respect to the code sections that are evicted from secondary. In one embodiment, computer program code is obtained in order to generate secondary-memory-eviction data that effectively identifies at least a first executable computer code section of the computer program code as a section to be evicted from the secondary memory during the execution of the computer program code. It should be noted that the secondary-memory-eviction data can be stored in a computer readable storage medium. It should also be noted that the secondary-memory-eviction data can be effectively integrated with executable computer code generated for the computer program code. By way of example, a compiler can be operable to generate executable code that includes secondary-memory-eviction data identifying one or more executable computer code sections to be selectively evicted from the secondary memory, as will be appreciated by those skilled in the art.

In accordance with another aspect of the invention, one or more executable computer code sections can be evicted from secondary memory when context of the execution is to change (e.g., when context of the execution is to switch from a first context of execution for a first process to second context of execution for a second process). Executable computer code sections can be evicted selectively (or invalidated) from the second memory, or the entire secondary memory can be evicted, or at least designated portion of the secondary memory can be invalidated to effectively evict executable computer program code from the secondary memory when context of the execution is to change.

In accordance with yet another aspect of the invention, one or more executable computer code sections of executable computer code can be evicted from the secondary memory during execution time of the executable computer code. In one embodiment, at least a first executable computer code section of a plurality of executable computer code sections is identified as a section to be evicted from the secondary memory and is evicted from the secondary memory accordingly. It should be noted that the executable code sections can, for example, be identified based on data provided by and/or effectively integrated with the executable computer code.

Those skilled in the art will also appreciate that the invention is especially suitable for enhancing the security of computing systems that use an instruction cache (I-cache). In particular, the invention allows selecting the sections of computer code considered to be important to security and ensuring that the executable sections are evicted from the I-cache before allowing the context of the execution to change. As a result, it would be difficult for a “spy” program to obtain information regarding the code sections by effectively observing the state changes of the I-cache.

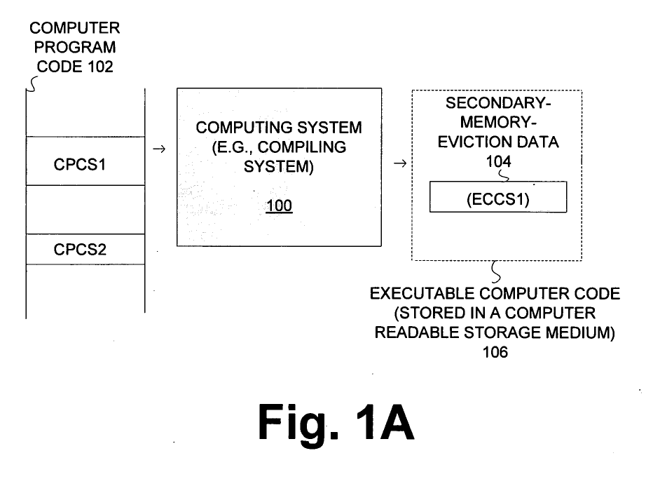

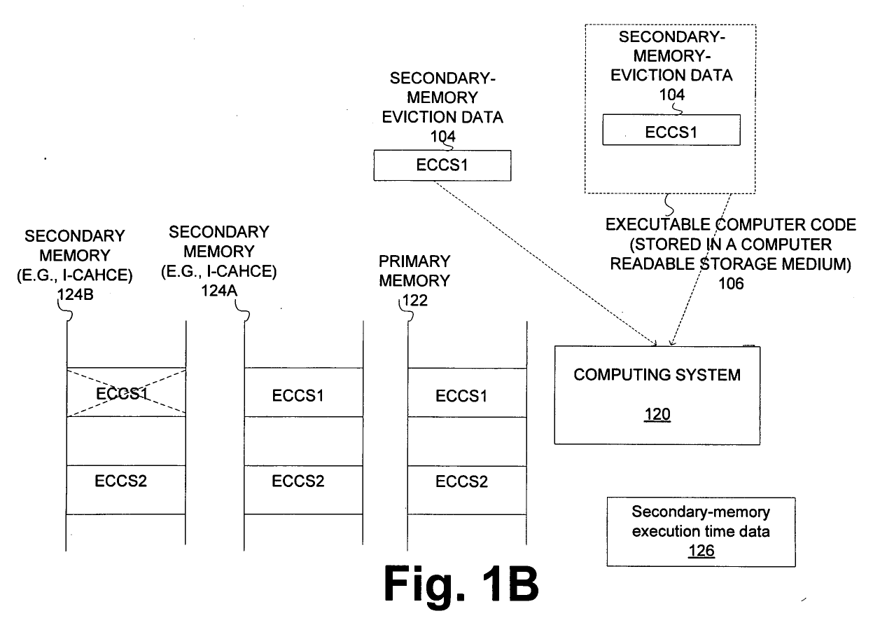

Embodiments of these aspects of the invention are discussed below with reference to FIGS. 1A-5. However, those skilled in the art will readily appreciate that the detailed description given herein with respect to these figures is for explanatory purposes as the invention extends beyond these limited embodiments.

FIG. 1A depicts a computing system 100 in accordance with one embodiment of the invention. It will be appreciated that the computing system 100 can, for example, be provided as various computing devices (e.g., a personal computer (pc), a mobile and/or smart phone, a server). Those skilled in the art will readily appreciate that the computing system 108 can, for example, include one or more processors operable to execute executable computer code and memory operable to store computer program code (not shown).

Referring to FIG. 1A, the computing system 100 can be operable to obtain computer program code (CPC) 102 that can be represented by a plurality of computer programs code sections (CPCS1 and CPCS2). As will be known to those skilled in the art, the computer program code (CPC) 102 can, for example, be source code written in a high-level computer programming language (e.g., source code written in C, C++, or Java programming language).

The computing system 100 can also be operable to effectively identify at least a first computer program code section (CPCS1) as a section to be evicted from secondary memory during execution of executable computer code for the computer program code 102. Typically, the secondary memory is provided for and/or in addition to primary memory operable to store the executable version of computer program code 102. As such, primary and secondary memory can both effectively support execution of an executable version of the computer program code 102. Secondary memory can, for example, provided, as cache memory to effectively improve execution time and computing. Those skilled in the art will readily appreciate that secondary memory can be operable to provide relatively faster access time than primary memory but may be smaller than primary memory. By way of example, secondary memory can be provided as an instruction cache (or an “I-cache,” as generally known in the art).

It will be appreciated that executable computer code sections can be evicted from secondary memory during execution time to improve security of computing systems. In particular, security of computing systems can be improved by effectively evicting executable computer code sections that are considered to be “important” and/or “critical” to security (e.g., code sections that may contain or may be associated with security keys, encryption keys, passwords, and so on). Generally, eviction of executable code from secondary memory can assist in masking differences or changes with respect to the state of the secondary memory that may be observed by external and/or unauthorized components (e.g., spyware programs, monitoring (or logging) programs).

Those skilled in the art will appreciate that a first program code section (CPCS1) may, for example, be identified by a programmer and/or developer as program code sections to mapped to do same section of secondary memory. In other words, a programmer or developer of the computer program code (CPC) 102 may effectively identify (or mark) a first computer program code section as a section to be evicted from secondary memory.

Moreover, it will be appreciated that the computing system 100 can be operable to analyze computer program code 102 in order to identify at least a first computer program code section (CPCS1) as a section to be evicted from section of secondary memory provided for a primary memory operable to store executable computer program code for the computer program code 102. As will be discussed in greater detail below, computer program code sections pertaining to security can be identified as counterparts of each other. As such, two or more computer program code sections (e.g., CPCS1 and CPCS2) can be identified as counterparts to be evicted from secondary memory.

Generally, the computing system 100 can be operable to generate secondary-memory-eviction data 104 for the computer program code 102. The secondary-memory-eviction data 104 can effectively identify at least a first executable computer code section (ECCS1) as a section to be evicted from secondary memory. Those skilled in the art will also appreciate that computing system 100 can be operable to store the secondary-memory-eviction data 104 to a computer readable storage medium (e.g., non-volatile memory, hard disk, Compact Disk (CD), volatile memory). Furthermore, the computing system 100 can be operable to generate executable computer program code 106 for the computer program code 102. As shown in FIG. 1A, secondary-memory-eviction data 104 may be effectively integrated into executable computer program code 106 and provided in a computer readable storage medium. Those skilled in the art will appreciate that the computing system 100 can, for example, be and/or include a compiler operable to generate executable computer code 106 for the computer program code 102. A complier can also be operable to analyze the computer program code 102 in order to effectively identify one or more computer program code sections (e.g., CPCS1 and CPCS2) to be evicted from the secondary memory. By way of example, executable computer program code 106 can be provided as data in an Executable and Linking Format (ELF) (e.g., an ELF file). As will be described in greater detail below, the secondary-memory-eviction data 104 can be provided in one or more sections of an ELF file.

As noted above, evicting (or invalidating) executable code sections of the secondary memory could effectively mask differences or changes with respect to the state of the secondary memory that may be otherwise observable to unauthorized and/or adverse entities (e.g., spy programs). It should be noted that executable code sections can be selectively evicted from the secondary memory when the context of the execution is switched. In particular, security of the computing system can be enhanced by selectively evicting executable code sections that are pertinent to security from the secondary memory before allowing the context of the execution to switch form a first context to a second context of execution.

Referring back to FIG. 1A, it should be noted that the secondary-memory-eviction data 104 can effectively identify first and second executable computer code sections 104 (ECCS1 and ECCS2) as counter part security sections to be evicted from secondary memory before switching the context of execution (e.g., allowing context of execution to be switched to another process to execute). Generally, the same executable code can be executed under a different contexts (or states) of the execution, as generally known in the art. Typically, different processes and/or application programs have different contexts of execution.

To further elaborate, FIG. 1B depicts a computing system 120 in accordance with another embodiment of the invention. Similar to the computing system 100 depicted in FIG. 1A, it will be appreciated that the computing system 120 can, for example, be provided as various computing devices (e.g., a personal computer (pc), a mobile and/or smart phone, a server) and it can include one or more processors operable to execute executable computer code and memory operable to store executable computer code (not shown). Those skilled in the art will also appreciate that the computing system 120 (depicted in FIG. 1B) and computing system 100 (depicted in FIG. 1A) can be the same system and/or effectively integrated and/or provided in the same computing system.

Generally, computing system 120 can be operable to obtain (e.g., receive, locate, generate, identify, determine) the secondary-memory-eviction data 104 associated with executable computer code 106 (shown in FIG. 1A). As noted above, the secondary-memory-eviction data 104 may, for example, be provided as a part of executable computer code 106. Typically, the computing system 120 is operable to store the executable computer code 106 in primary (or main) memory 122 when the computing system 120 is to execute the executable computer code 106. As generally known in the art, memory 122 can be provided to effectively support the execution of the executable computer code 106 and may be referred to as primary memory. Secondary memory 124 can also be provided to effectively support execution of the executable computer code 106. As noted above, secondary memory, such as the secondary memory 124 (depicted in FIG. 1B), can function as a cache (e.g., an I-cache and/or a D-cache) for storing data and/or instructions pertaining to execution of the executable computer code 106.

Referring to FIG. 1B, computing system 120 can be operable to store executable computer code 106 including first and second executable computer code sections (ECCS1 and ECCS2) in the secondary memory 124. Moreover, computing system 120 can be operable to identify, based on the secondary-memory-eviction data 104, the first executable computer code section (ECCS1) as a section to be evicted from the secondary memory, and accordingly evict the first executable computer code section (ECCS1) from the secondary memory in order to reduce the observable differences of the secondary memory. The computing system 120 can, for example, evict the executable computer code section (ECCS1) from the secondary memory when context of execution is to be switched. As another example, the computing system 120 can, for example, evict the executable computer code section (ECCS1) from the secondary memory after a determined amount of time. It should be noted that the computing system 120 can be operable to store information required for evicting executable computer code from the secondary memory in secondary-memory execution time data 126. By way of example, the secondary-memory execution time data 126 can be provided in and/or as a “process descriptor” 126, as will be known to those skilled in the art. As noted above, executable computer program code 106 can, for example, be provided as data in an Executable and Linking Format (ELF) file, wherein the secondary-memory-eviction data 104 can be provided in one or more sections of the ELF file. As such, the computing system 120 can be operable to effectively copy the secondary-memory-eviction data 104 from the ELF file to a “process descriptor” 126 which can be used to manage execution of computer code including effective execution switches as will be readily known to those skilled in the art. In view of the foregoing, those skilled in the art will readily appreciate that the computing system 120 can be and/or include an Operating System (OS) operable to evict executable code from secondary memory 124.

Generally, execution of executable computer code can be initiated in a first context of execution. Thereafter, secondary memory (e.g., an instruction-cache provided for execution of the executable computer code) can be evicted when context of execution is to be switched from the first context of execution, thereby evicting from the secondary memory any executable computer code that may have been stored in the secondary memory before allowing context of execution to be switched to a second context of execution.

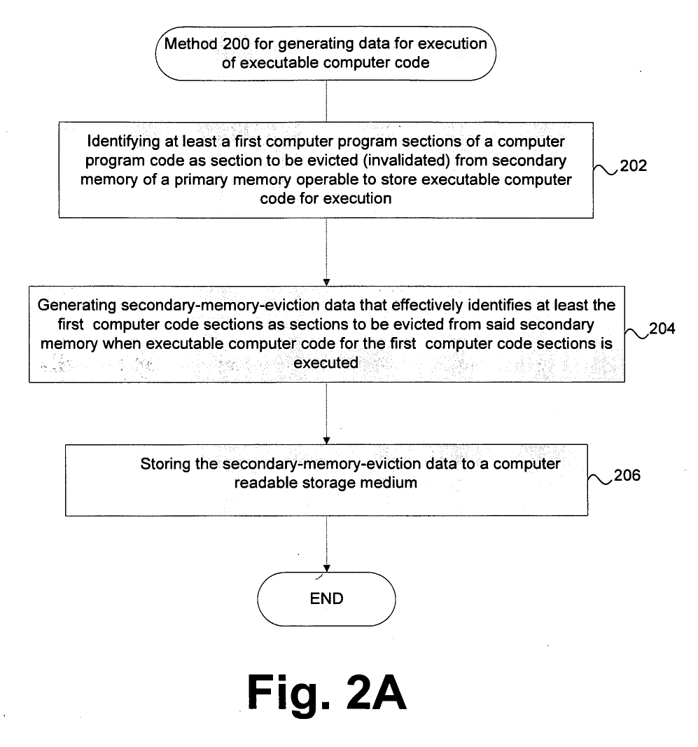

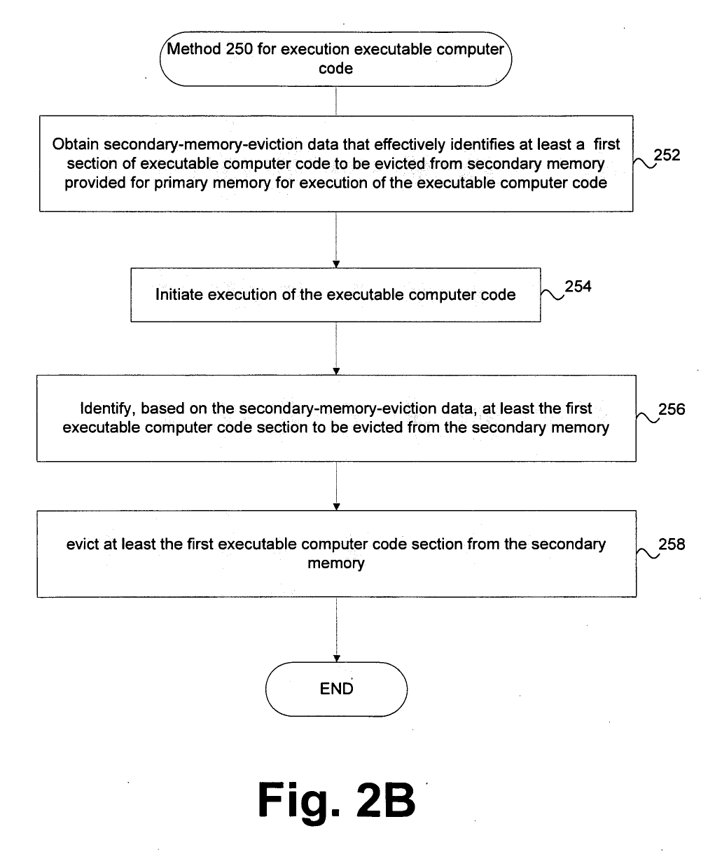

FIG. 2A depicts a method 200 for generating data for execution of executable computer code by a computing system in accordance with one embodiment of the invention. Method 200 can, for example, be used by the computing system 100 depicted in FIG. 1A. Referring to FIG. 2A, initially, at least a first computer program section of computer program code is identified (202) as a section to be evicted (or invalidated) from secondary memory. Typically, the secondary is provided for primary (or main) memory operable to store executable computer code including the executable computer code for the first computer program section. Next, secondary-memory-eviction data is generated (204). The secondary-memory-eviction data effectively identifies at least the first and second computer code sections as sections to be evicted from the secondary memory when executable computer code for said first and a second computer code sections is executed. Thereafter, the secondary-memory-eviction data is stored (206) to a computer readable storage medium. Method 200 ends after the secondary-memory-eviction data is stored (206) to a computer readable storage medium.

FIG. 2B depicts a method 250 for execution of executable computer code in accordance with one embodiment of the invention. Method 250 can, for example, be used by the computing system 120 depicted in FIG. 1B. Referring to FIG. 2B, initially, secondary-memory-eviction data is obtained (252). The secondary-memory-eviction data can effectively identify at least a first section of executable computer code to be evicted from secondary memory provided for primary memory for execution of the executable computer code. Next, execution of said executable computer code is initiated (254). Thereafter, at least the first executable computer code section is identified (256) to be evicted from the secondary memory. Accordingly, the first executable computer code section is evicted from the secondary memory. Method 250 ends after evicting (258) the first executable computer code from the secondary memory.

As noted above, modern microprocessors can use an instruction cache (I-cache). An instruction cache can improve the execution time and consequently the overall performance of a computing system. More particularly, an I-cache can store the most frequently executed instructions and provide them to the processor in a more efficient manner than accessing them for the primary memory (e.g., Random Access Memory). Unfortunately, I-cache can also create security problems by allowing the status of the I-cache to be observed.

When a processor needs to read instructions from the main memory, it can first check the I-cache to see if the instructions are stored in the I-cache. If the instructions are in the I-cache (“cache hit”), the processor can obtain them from the I-cache instead of accessing the primary (or main) memory with significantly longer latency. Otherwise (“cache miss”), the instructions are read from the memory and a copy of them is stored in the I-cache. Typically, each “I-cache miss” causes accessing a higher level of memory (i.e., a higher level of cache when more than one level is provided or main memory) and may cause relatively more delays in execution.

By keeping track of the changes (or states) of the I-cache, it is possible to obtain information regarding the code being executed. For example, “spy” code/process can keep track of the changes to the state of I-cache (i.e., changes to metadata during the execution of a cipher process). The spy code/process can run simultaneously or quasi-parallel with the cipher process and determine which instructions are executed by the cipher.

Those skilled in the art will know that sliding windows exponentiation can generate a key dependent sequence of modular operations and “OpenSSL” can use different functions to compute modular multiplications and square operations (see “Yet Another MicroArchitectural Attack: Exploiting I-cache,” Proceedings of the 2007 ACM Workshop on Computer Security Architecture, pages 11-18, ACM Press, Fairfax, Va., USA, Nov. 2, 2007). As a result, an adversary can run a spy routine and evict either one of these functions. The adversary can determine the operation sequence (squaring/multiplication) of RSA. In an attack scenario of a “protected” crypto process executing RSA signing/decryption operations and an adversary executing a spy process simultaneously or quasi-parallel executing: the spy routine can, for example, (a) continuously execute a number of dummy instructions, and (b) measure the overall execution time of all of these instructions in such a way that these dummy instructions precisely maps to the same I-cache location with the instructions of multiplication function. In other words, the adversary can create a “conflict” between the instructions of the multiplication function and the spy routine. Because of this “conflict,” either the spy or multiplication instructions can be stored in I-cache at a given time. Therefore, when the cipher process executes the multiplication function, the instructions of the spy routine are “evicted” from I-cache. This “eviction” can be detected by the spy routine because when it re-executes its instructions the overall execution time will suffer from I-cache misses. Thus, the spy can determine when the multiplication function is executed. This information can directly reveal the operation sequence (multiplication/squaring) of RSA. For the square & multiply exponentiation algorithm this can reveal a secret key in its entirety whereas for sliding windows exponentiation the attacker may learn more than half of the exponent bit. Further details of I-cache analysis are described in “Yet Another MicroArchitectural Attack: Exploiting I-cache,” Proceedings of the 2007 ACM Workshop on Computer Security Architecture, pages 11-18, ACM Press, Fairfax, Va., USA, Nov. 2, 2007,” which is hereby incorporated by reference herein in its entirety an for all purposes.

To elaborate even further, a simplified exemplarily I-cache analysis using RSA will be described below. However, it should be noted that use of I-cache can pose a generic threat applicable to virtually any process, application, or algorithm, as will be appreciated by those skilled in the art.

Considering the pseudocode representative of a simplified template of some cryptographic operations such as RSA exponentiation:

```
for all bits of secret_key
  if(secret_key[i]=1)
    execute Code Section 1
  else
    execute Code Section 2
end for
```

where “secret_key[i]” denotes the ith bit of a variable secret key (secret_key).

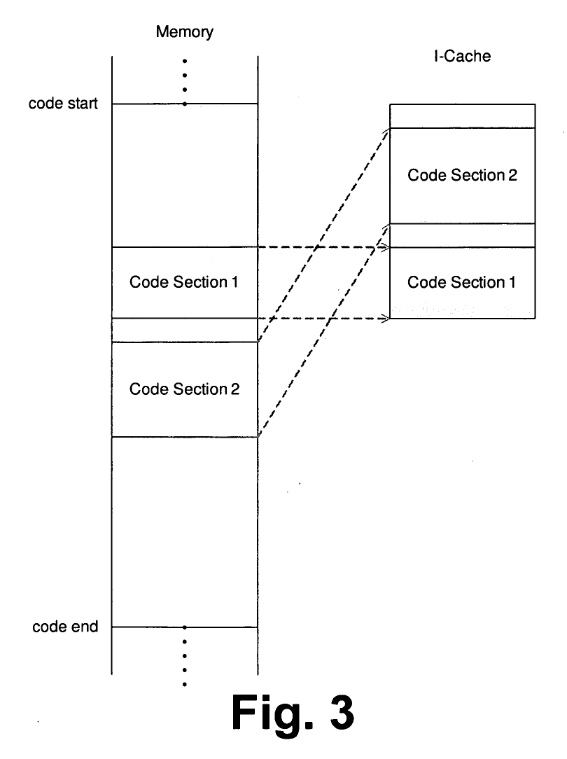

Referring now to FIG. 3, assume that first and second Code Sections 1 and 2 (CS1 and CS2) as placed in the (final) executable code map to different regions of an I-cache. In this example, an I-cache spy (or attack) process can examine the I-cache states during the operation of the pseudocode noted above and may be able to determine when each one of the CS1 and CS2 are executed. This is due to the fact that first and second Code Sections 1 and 2 (CS1 and CS2) can map to different I-cache regions and their execution could affect different I-cache regions and thus resulting in “observable” differences in state of the I-cache.

An I-cache may be attacked when key dependent variations in the flow of instructions map to different regions of the I-cache. However, if such instructions (e.g., multiplication and square operations in RSA/OpenSSL) are evicted from the I-cache (or invalidated), such attacks cannot obtain the operational sequence.

Generally, code sections can be identified to be evicted from the I-cache. These sections can, for example, be selected based on the security context of various computer codes. For example, if there is a control flow variation in a computer program that depends on a secret or sensitive data (such as the example noted above) then the sections can be considered to be sections critical to the security (or “critical sections”).

It should be noted that a “critical section” can be considered to have one or more counterparts. For example, code section CS1 and CS2 in the example above can be considered to be counterparts of each other and, as such, be marked for eviction from an I-cache. In addition, counterpart code sections can be made (or modified) to have or effectively exhibit the same code size. By way of example, in an “if-then-else statement,” the code sections (or blocks) immediately following the “if” and “else”, respectively, can be considered to be counterparts of each other. As another example, in an “if” statement without an “else” clause, the code that immediately follows the code block of the “if” statement can be considered to be the counterpart of the code block of the “if” statement. In a “switch” statement, there may be more several code blocks that are counterparts of each other, and so on. It should be noted that counterparts may be mapped to the same section of the cache and subsequently evicted in accordance with the invention. Techniques for effective mapping of code sections are disclosed in greater detail in U.S. patent application No. (Atty Docket No. SISAP077/CSL08-TC09) entitled: “EFFECTIVE MAPPING OF CODE SECTIONS TO THE SAME SECTION OF SECONDARY MEMORY TO IMPROVE THE SECURITY OF COMPUTING SYSTEMS,” which is hereby incorporated by reference herein for all purposes

In particular, sections of code section pertaining to and/or associated with security (e.g., critical sections) can be selectively evicted from the I-cache when the context of the execution switches (e.g., context of execution is switched from a first process to as second process).

Those skilled in the art will readily appreciate that an Operating System (OS) can be operable to selectively evict critical sections of executable code from the I-cache when the context of the execution switches.

Typically, the Operating System (OS) would need to identify the critical sections. The Operating System (OS) may be operable to evict code sections from the I-cache only for selected programs (e.g., application selected to run with increased security). Generally, the details of the CPU architecture and I-cache are visible to the Operating System. Additional information can be provided to the Operating System during “build” time. By way of example, a compiler can provide the information needed for selective eviction of code from the I-Cache in an object file. As a result, an Operating System (OS) can determine whether to perform selective eviction of code from the I-Cache. The Operating System (OS) can then store the information in a process descriptor when the program is initiated. The process descriptor can be used at runtime to ensure the selective eviction takes place each time the context of execution switches to a different process.

More generally, an I-cache may be invalidated when the context of execution switches. In other words, the entire I-cache may be invalidated to ensure that no critical section of code remains in the I-cache. Alternatively, only a particular portion of the I-cache can be used to store executable computer code and only the particular portion can be selectively invalidated when context of execution is to switch.

Those skilled in the art will appreciate that a compiler can be operable to effectively identify and/or select code sections to be evicted from the I-cache. However, to accomplish these tasks, a compiler may need more input that would be conventionally required. It will be appreciated that the additional data, can, for example, be provided at “build” time. By way of example, instead of the conventional command: “gcc -o program.exe program.c”, flags and/or additional command line arguments can be used:

gcc -enablelcachemitigation -o program.exe program.c

It should be noted that critical sections and their counterparts can be identified manually, and effectively highlighted in the source code, for example, be using compiler specific preprocessing commands or flags. By way of example, the exemplary code noted above can be modified as shown below:

```
    for all bits of secret_key
      if(secret_key[i]=1)
#StartCriticalSection label1 part1
        execute Code Section 1
#EndCriticalSection label1 part1
      else
#StartCriticalSection label1 part2
        execute Code Section 2
#EndCriticalSection label1 part2
    end for
```

This would allow a compiler to effectively identify code sections 1 and 2 (CS1 and CS2) as critical code section and as counterparts of each other to be mapped to the same section of the I-cache. It should also be noted that a compiler can be operable to analyze the entire code or one or more sections of the code that have been effectively marked for analysis in order to detect critical code sections as counterparts. By way of example, code sections that show control flow variations based on a value (e.g., secret value) can be identified.

A compiler can provide data pertaining to computer code sections that are to evicted from the I-cache to an Operating System, for example, by providing the data in an object (or executable) file (e.g., an Executable and Linking Format (or ELF) object/program file). This data can indicate whether the object (or executable) file requires selective eviction and, if so, what sections of the code need to be evicted from the I-cache.

By way of example, a new flag in “e_flags” structure in the ELF header can be provided. Alternatively, a new file type, i.e., a new value for “e_type” can be used to identify the executable code sections that are to be selectively evicted from the I-cache during execution time.

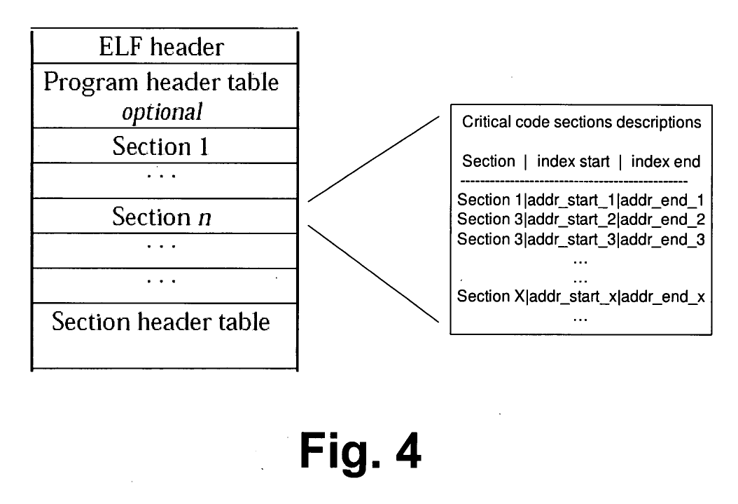

In addition, a special section type of “ELF” files, i.e., with a new value of “sh_type” can be defined. This ELF section can include the descriptions of the security critical code sections (SCCS) in other ELF sections in the same program/object file. To elaborate even further, FIG. 4 depicts an exemplary ELF file in accordance with one embodiment of the invention. Referring to FIG. 4, an “n” section of the ELF file can be a special section that holds the descriptions for security critical code sections (SCCS), namely security critical code sections 1 and 3. As shown in FIG. 3, the code for security critical code section can start from “addr_start_1,” which can be a virtual address relative to the start of a code section 1. The description for code section 3 can include two different security critical code sections (SCCS), and so on. Section n can also hold additional information, for example, counterpart information identifying critical code sections (SCCS) that are counterparts of each other.

As an alternative exemplary embodiment, each security critical code sections (SCCS) can be placed in a separate section of an ELF file. A section that has one or more critical code sections (SCCS) can be identified, for example, by using a new “sh_flags” value that indicates its status.

Another technical issue is effective handling of the security critical code sections (SCCS) by the Operating System (OS). Taking the Linux Operating System as an example, when the Linux Operating System needs to initialize a program, it first modifies the process making a “execve( )” call, loads the program, resolves the symbols, and lets the process with the new program run. In accordance with one embodiment of the invention, an Operating System can check an executable file (e.g., an ELF file”) to determine whether to perform I-cache eviction for a particular program. By way of example, a Linux Operating System can check an ELF file during the initialization process of a program in order to determine whether to perform selective eviction of the I-Cache.

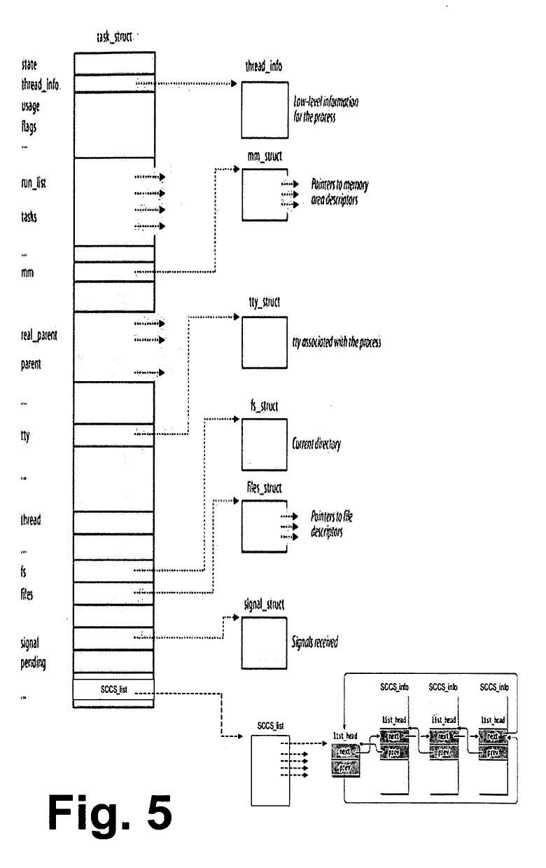

The data for eviction of the I-cache can, for example, be stored as part of the “process descriptor,” as will be known to those skilled in the art. To further elaborate, FIG. 5 depicts an exemplary “process descriptor” in accordance with one embodiment of the invention. Generally, if a process requires a selective eviction feature, an indication can be made in the “process descriptor” for the process. For example, the “flags” field of the “process descriptor” can have a flag indicating a selective/enabling a selective I-cache eviction option. If the process requires selective eviction, the corresponding bit in “flags” field can be set to one (1), otherwise it can be set to zero (0). As another example, an indicator can be stored in “thread_info” even defining different process states where selective eviction is performed based on the current state of the process.

If a process requires selective eviction, information pertaining to the security critical code sections (SCCS) can also be stored in the “process descriptor” for the process. For example, “task_struct” can be expanded to define a new pointer (“SCCS_list”) for it. This pointer can be either NULL (if it is a regular process), or points to a SCCS_list vector (if selective eviction is needed). The details of each security critical code section can be stored in “SCCS_info” data structure. This data structure can also include “list_head structure” (defined and used in Linux), which allows them to be stored in doubly linked lists. Each doubly linked list can contain the “SCCS_info” of the code sections that are counterparts. For example, the details of the code sections 1 and 2 in the above example can be placed in the same doubly linked list, which will have only these two “SCCS_info” structures. The “SCCS_list” vector can hold the pointers to each of these doubly linked lists.

Each time the context of execution is to switch, the Operating System (OS) can check the “process descriptor” to determine whether to perform selective eviction of the I-cache for the process. If it is determined, based on the “process descriptor,” not to perform selective eviction of the I-cache for the process, then the context of the execution can switch in a conventional manner. However, if it is determined based on the “process descriptor,” to perform selective eviction of the I-cache for the process, the OS can extract the required information from “SCCS_list” and perform the requested selective eviction of the I-Cache before the context of the execution is switched (e.g., passing the execution to the next scheduled thread.

Those skilled in the art will readily appreciate that the invention can be applied to multi-level caching systems. As such, the techniques discussed above can be readily applied to a third level cache, fourth level-cache, and so on.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of generating data for execution of executable computer code, wherein said computer-implemented method comprises:
obtaining, by a computing system, computer program code that includes a plurality of computer program code sections;
identifying, by said computing system, at least a first computer program section of said computer program code as a section to be evicted from secondary memory with respect to primary memory operable to store said executable computer code for execution by said computing system;
generating, by said computing system, secondary-memory-eviction data that effectively identifies at least said first computer code section as a section to be evicted from said secondary memory when executable computer code for said computer program code is executed; and
storing, by said computing system, said secondary-memory-eviction data to a computer readable storage medium.

2. The computer-implemented method of claim 1, wherein said identifying identifies said first computer program section as a section to be effectively evicted from a secondary memory when the context of the execution is to be switched.

3. The computer-implemented method of claim 1, wherein said identifying identifies said first computer program section as a section that is associated with one or more of the following:
one or more conditional statements, a change in flow, an “if and else” statement, a case statement, computer program code immediately following or proceeding a conditional statement, computer program code immediately following or proceeding a conditional statement an “if and else” statement, computer program code associated with security of said computing system, computer program code that includes a security value and/or variable.

4. The computer-implemented method of claim 1, wherein said computer-implemented method further comprises:
generating executable computer code for said computer program code including first executable computer code section for said first computer program code section.

5. The computer-implemented method of claim 1, wherein said first computer program section is effectively marked in said computer program code as a section to be evicted from said secondary memory when said obtaining obtains said computer program code.

6. A computer-implemented method of claim 1, wherein said computing system includes a complier.

7. A computer-implemented method of claim 1,
wherein said secondary memory is operable to provide relatively faster access time than said primary memory but is smaller than said primary memory, and
wherein said secondary memory is an instruction cache (I-cache) memory provided for said primary memory.

8. The computer-implemented method of claim 1,
wherein said generating generates executable computer code is an Executable and Linking Format (ELF) that includes said secondary-memory-eviction data.

9. The computer-implemented method of claim 1,
wherein said executable computer code includes one or more of the following: object data, binary data, data in an Executable and Linking Format (ELF), and
wherein said identifying identifies two or more sections of said computer program code as a counter part sections to be evicted from secondary memory.

10. A computer-implemented method of executing executable computer code by a computing system operable to store said executable computer code in primary memory and an instruction cache during execution of said executable computer code, said computer-implemented method comprising:
initiating execution of executable computer code in a first context of execution, wherein execution of said executable computer code can effectively cause at least a portion of said executable computer code to be stored in said instruction cache; and
thereafter evicting said instruction-cache when context of execution is to be switched from said first context of execution to a second context of execution, thereby evicting from instruction cache any portion of said executable computer code that may have been stored in said secondary memory before allowing context of execution to be switched to said second context of execution.

11. The computer-implemented method of claim 10, wherein said evicting selectively evicts one or more code sections of said executable computer code that have been effectively marked to be evicted from said I-Cache.

12. The method of claim 10,
wherein said method further comprises: storing at least a plurality of computer code sections of said executable computer code in a first designated portion of said instruction-cache, and
wherein said evicting evicts said first designated portion of said instruction-cache when context of execution is to be switched from said first context of execution.

13. The method of claim 10,
wherein said method further comprises: allowing only a first portion of said instruction-cache to be used to store said executable computer code; and
wherein said evicting evicts said first portion of said instruction-cache.

14. A computer-implemented method of executing executable computer code by a computing system operable to store said executable computer code in primary memory and secondary memory, said computer-implemented method comprising:
obtaining, by a computing system, secondary-memory-eviction data that effectively identifies at least a first executable computer code section of said executable computer code as a section to be evicted from said secondary memory;
initiating execution of said executable computer code;
thereafter, identifying, based on said secondary-memory-eviction data, at least said first executable computer code section of said plurality of executable computer code sections as a sections to be evicted from said secondary memory; and
evicting, based on said identifying, said first executable computer code section from said secondary memory, thereby selectively evicting said first executable computer code section from said second memory.

15. The computer-implemented method of claim 14, wherein said evicting evicts said first executable computer code section before execution of said executable computer code has completed.

16. The computer-implemented method of claim 14, wherein said evicting evicts said first executable computer code section when context of execution is to be switched.

17. The computer-implemented method of claim 16, wherein said switch in context of execution comprises one or more of the following:
switching the context of execution from a first process to another process; and
switching the context of execution from execution of said executable computer code to execution of another executable computer code.

18. The computer-implemented method of claim 16,
determining whether said first executable computer code is stored in said secondary memory; and
evicting said first executable computer code from said secondary memory when said determining determines to evict said first executable computer code secondary memory.

19. The computer-implemented method of claim 14, wherein said computer-implemented method further comprises:
generating, by said computing system, secondary-memory-eviction run time data that effectively identifies said at least first and a second executable computer code sections as sections to be evicted said secondary memory.

20. The computer-implemented method of claim 19, wherein said secondary-memory-eviction run time data is provided by and/or as a process descriptor.

21. A computer readable storage medium storing at least executable computer code, wherein said computer readable storage medium includes:
executable computer program code operable to identify a first executable computer code section of said plurality of executable computer code sections as a sections to be evicted from secondary memory; and
evict, based on said identifying, said first executable computer code section from said secondary memory after execution of said executable computer code is initiated, thereby selectively evicting said first executable computer code section from said second memory.

22. The computer readable storage medium of claim 21, wherein said evicting evicts said first executable computer code section from said secondary memory when context of execution is to switch from a first context of execution to a second context of execution.

23. A computing system, wherein said computing system is operable to:
store executable computer code in primary memory and secondary memory for execution of said executable computer code;
identify at least a first executable computer code section of said executable computer code as a section to be evicted from said secondary memory;
evicting, based on said identifying, said first executable computer code section from said secondary memory after execution of said executable computer code has been initiated, thereby selectively evicting said first executable computer code section from said second memory.
